(19) United States
(12) Patent Application Publication
(10) Pub. No.: US 2006/0149513 A1
(43) Pub. Date: Jul. 6, 2006

(54) Method and system for simulating a surface acoustic wave on a modeled structure

(76) Inventor: Sangpil Yoon, Campbell, CA (US)

Correspondence Address: EPSON RESEARCH AND DEVELOPMENT INC;INTELLECTUAL PROPERTY DEPT, 150 RIVER OAKS PARKWAY, SUITE 225, SAN JOSE, CA, 95134, US

(21) Appl. No.: 11/031,906

(22) Filed: Jan. 6, 2005

(51) Int. Cl. G06F 17/10

(52) U.S. Cl. 703/2

(57) ABSTRACT

A method of simulating a surface acoustic wave (SAW) on a structure that is modeled on a computer or other processor-based device enables the testing of actual SAW devices or to develop improved SAW devices. In this method, the modeled structure is preferably that of a corrugated structure that includes an electrode disposed on top of a piezoelectric substrate. A meshfree method then is applied to the modeled structure using Newton's equation of motion and Gauss's equation of charge conservation as governing equations. Subsequently, a set of equations is solved simultaneously to obtain numerical results.

### BACKGROUND OF THE INVENTION

1. Field of the Invention

This invention relates generally to the modeling and analysis of surface acoustic wave devices and, more particularly, to a method and a system of simulating a surface acoustic wave on a modeled structure.

2. Description of the Related Art

The Finite Element (FE) method is a popular and widely used numerical method for obtaining numerical solutions to a broad range of engineering disciplines. Typical FE analysis procedures involve the “discretization” of a given problem domain into simple geometry shapes called elements. Physics laws are applied locally (on an element level) to describe the behavior of the elements, and the elements then are reconnected at nodes. This process results in simultaneous algebraic equations, which are solved numerically by computers.

The FE method, however, has critical drawbacks due to its necessary requirement of discretizations. For example, FIGS. 1A, 1B, and 1C show the inconveniences of FE discretization in a structure composed of top portion 102 on top of main body portion 104. As shown in FIG. 1A, FE discretization does not allow nodal mismatches at interface 106, where top portion 102 and main body portion 104 meet. As a result, as shown in FIG. 1B, the requirement for compatibility at interface 106 forces distribution of more elements in main body portion 104, which leads to increased computational cost, and irregular distribution of element aspect ratio. On the other hand, as shown in FIG. 1C, larger elements in top portion 102 lead to coarse elements in main body portion 104, which leads to poor accuracy. As a result, even simple geometries, such as the structures shown in FIGS. 1A-1C, using FE may require high computational cost or result in poor accuracy.

In view of the foregoing, there is a need to provide a method and a system of obtaining numerical solutions for structures with little computational cost and with a high degree of accuracy.

### SUMMARY OF THE INVENTION

Broadly speaking, the present invention fills these needs by providing a method and a system of simulating a surface acoustic wave on a modeled structure. It should be appreciated that the present invention can be implemented in numerous ways, including as a method, a system, or a device. Several inventive embodiments of the present invention are described below.

In accordance with a first aspect of the present invention, a method of simulating a surface acoustic wave on a modeled structure is provided. In this method, a structure that is capable of generating a surface acoustic wave, e.g., a corrugated structure that may also include an electrode disposed on top of a piezoelectric substrate, is modeled. A meshfree method then is applied to the modeled structure using Newton's equation of motion and Gauss's equation of charge conservation as governing equations. Subsequently, a set of equations is solved simultaneously to obtain numerical results.

In accordance with a second aspect of the present invention, a computer readable medium having program instructions for simulating a surface acoustic wave on a modeled structure is provided. The computer readable medium includes program of instructions for modeling a structure that is capable of generating a surface acoustic wave and program instructions for applying a meshfree method to the modeled structure using Newton's equation of motion and Gauss's equation of charge conservation as governing equations. Additionally, the computer readable medium includes program instructions for solving a set of equations simultaneously to obtain numerical results.

In accordance with a third aspect of the present invention, a computer system for simulating a surface acoustic wave on a structure that is capable of generating a surface acoustic wave is provided. The computer system includes a memory configured to store or receive a meshfree analysis program and a processor configured to execute the meshfree analysis program residing in the memory. The meshfree analysis program includes program instructions for applying a meshfree method to the model using an equation of motion as a governing equation, and program instructions for solving a set of equations simultaneously to obtain numerical results.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, and like reference numerals designate like structural elements.

FIGS. 1A, 1B, and 1C show the inconveniences of Finite Element discretization in a structure composed of a top portion on top of a main body portion.

FIGS. 2A and 2B are side views of corrugated structures, in accordance with embodiments of the present invention.

FIG. 3 is a flowchart diagram of a high level overview of a method of simulating a surface acoustic wave on a modeled structure, e.g., a modeled corrugated structure, in accordance with one embodiment of the present invention.

FIG. 4 is a flowchart diagram of a more detailed overview of the method operations for applying a meshfree method to a corrugated structure, in accordance with one embodiment of the present invention.

FIGS. 5A and 5B are more detailed views of the corrugated structures shown in FIGS. 2A and 2B, respectively.

FIG. 6 is a side view of the simplified problem domain, in accordance with one embodiment of the present invention.

FIG. 7 is a simplified block diagram of a high level overview of a computer system for simulating a surface acoustic wave in a structure, in accordance with one embodiment of the present invention.

FIGS. 8A and 8B show two discretizations with different corrugation widths, in accordance with embodiments of the present invention.

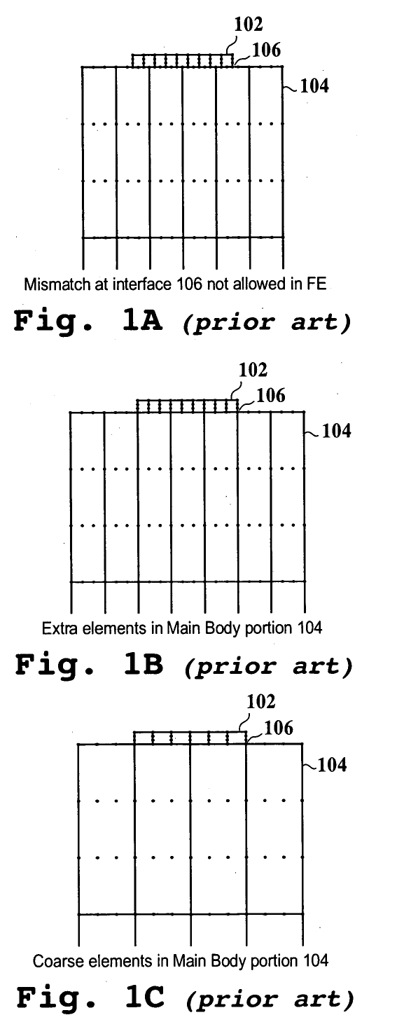

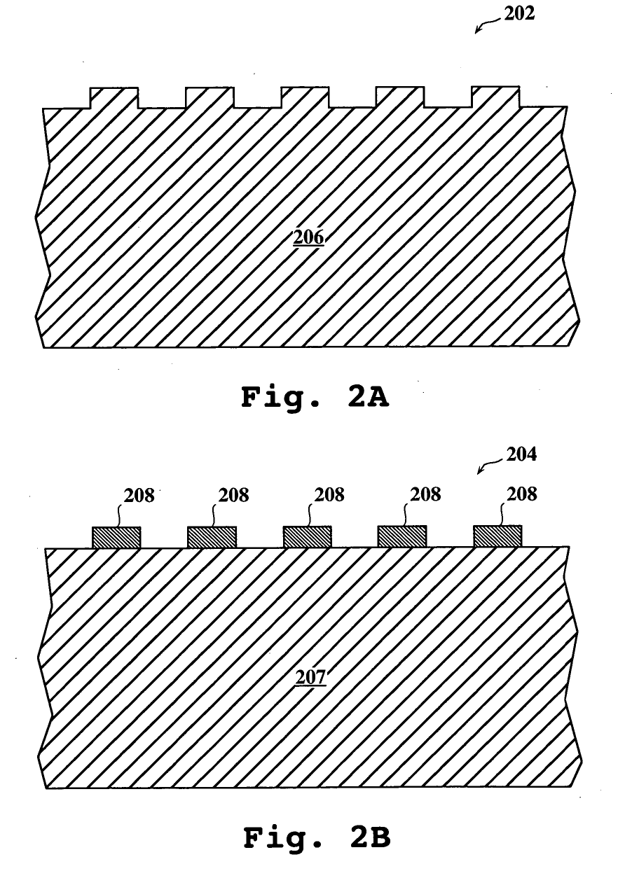

### DETAILED DESCRIPTION OF THE EXEMPLARY EMBODIMENTS

An invention is described for a method and a system for simulating a surface acoustic wave (SAW) on a modeled structure. It will be apparent, however, to one skilled in the art, in light of the present disclosure, that the present invention may be practiced without some or all of these specific details. In other instances, well known process operations have not been described in detail in order not to unnecessarily obscure the present invention.

The embodiments described herein provide a method and a system of simulating a SAW on a structure modeled on a computer or other computational device. In one embodiment, as will be explained in more detail below, a meshfree method is applied to a model of a corrugated structure using Newton's equation of motion as a governing equation. The meshfree method is applied to minimize the extra burden involved with generating elements associated with Finite Element (FE) method in the numerical analysis of a traveling SAW. The meshfree method does not require elements to discretize the problem domain. Instead, a simple scattering of nodes in the problem domain replaces the discretization required in the FE method. Unlike the FE method for which the approximation of field unknowns is performed on each element, the meshfree method allows a global level of approximation that eliminates the use of elements.

FIGS. 2A and 2B are side views of corrugated structures, in accordance with embodiments of the present invention. A corrugated structure is a series of periodic, alternating grooves and ridges. SAW devices used as filters, resonators, oscillators, etc., in electronic devices, typically have a corrugated structure. In general, the detection mechanism of a SAW device is an acoustic wave. As the acoustic wave propagates through the material of the SAW device, any changes to the characteristics of the propagation path affect the velocity and/or amplitude of the acoustic wave. Changes in velocity can be monitored by measuring the frequency or phase characteristics of the SAW device and can then be correlated to the corresponding physical quantity being measured. Applications of SAW devices include mobile communications (radio frequency filters and intermediate frequency filters), automotive applications (port resonators), medical applications (chemical sensors), and industrial and commercial applications (vapor, humidity, temperature, and mass sensors).

FIG. 2A shows an embodiment of a corrugated structure. The SAW device uses a piezoelectric material to generate the acoustic wave. It should be appreciated that its piezoelectric property enables the material to produce a voltage when subjected to mechanical stress. Conversely, the application of an electrical field creates mechanical stress in the piezoelectric material, which propagates through corrugated structure 202 and is then converted back to an electric field for measurement. As shown in FIG. 2A, corrugated structure 202 is comprised of piezoelectric substrate 206, which is composed of a piezoelectric material. Exemplary piezoelectric materials include quartz (SiO₂), barium titanate (BaTiO₃), lithium tantalate (LiTaO₃), lithium niobate (LiNbO₃), gallium arsenide (GaAs), silicon carbide (SiC), langasite (LGS), zinc oxide (ZnO), aluminum nitride (AlN), lead zirconium titanate (PZT), polyvinylidene fluoride (PVdF), etc. Of course, any suitable piezoelectric material may be used for piezoelectric substrate 206.

FIG. 2B shows an alternative embodiment to the corrugated structure of FIG. 2A. Corrugated structure 204 includes electrodes 208 disposed on top of piezoelectric substrate 207. One skilled in the art will appreciate that electrode 208 is a conductor used to make contact with piezoelectric substrate 207. Exemplary electrode 208 materials include aluminum, copper, gold, conducting polymers, etc. A series of electrodes 208 disposed on top of piezoelectric substrate 207 create the alternating parallel grooves and ridges of corrugated structure 204. FIG. 2B shows electrodes 208 having a rectangular shape when viewed from a side. However, electrodes 208 may have any suitable shape, such as a triangle, a trapezoid, a square, etc.

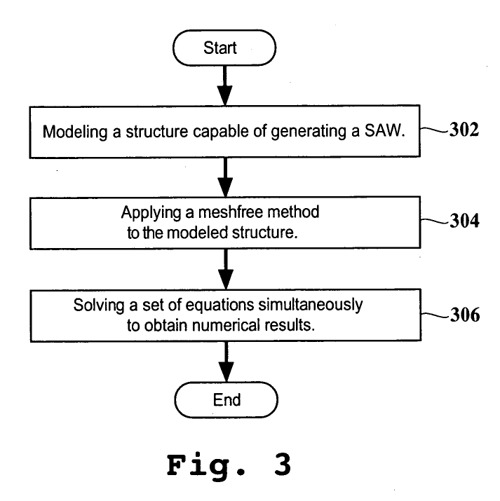

FIG. 3 is a flowchart diagram of a high level overview of a method of simulating a surface acoustic wave on a modeled structure, in accordance with one embodiment of the present invention. Starting in operation 302, a structure capable of generating a surface acoustic wave, e.g., a corrugated structure of a type described in connection with either FIGS. 2A or 2B, is modeled. In one embodiment, as shown in FIG. 2A, the modeled structure is that of a piezoelectric substrate, i.e., an integral piezoelectric structure. In another embodiment, as shown in FIG. 2B, the modeled corrugated structure is that of a piezoelectric substrate with electrodes disposed on top of the substrate. The modeling of the structure includes a modeling of its dimensions and those of its physical properties that have an effect on the structure's ability to propagate a surface acoustic wave. It should be noted that the modeled structure can represent a real world device under test. Alternatively, the modeled structure can be a representation of a hypothetical structure. Thus, in addition to enabling the testing of surface acoustic wave characteristics of real world devices, the invention also provides a tool for the discovery or manufacture of new structures having excellent surface acoustic wave propagation characteristics.

Returning to FIG. 3, as will be explained in more detail below, a meshfree method is then applied to the modeled structure in operation 304. In one embodiment, if the modeled corrugated structure is that of a piezoelectric substrate, the meshfree method is applied using Newton's equation of motion as a governing equation. On the other hand, in another embodiment, if the modeled corrugated structure includes electrodes disposed on top of a piezoelectric substrate, the meshfree method is applied using Newton's equation of motion and Gauss's equation of charge conservation as the governing equations. Subsequently, in operation 306, the set of equations are solved simultaneously to obtain numerical results, which, as will be explained in more detail below, include displacement values or electric potential values.

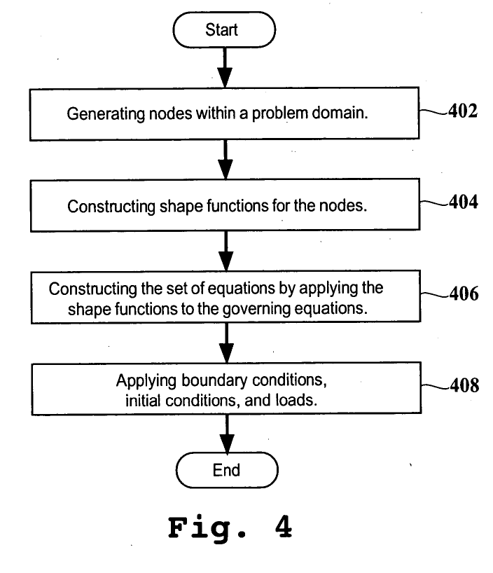

FIG. 4 is a flowchart diagram of a more detailed overview of the method operations for applying a meshfree method to a modeled corrugated structure, in accordance with one embodiment of the present invention. Starting in operation 402, nodes are generated within a problem domain. As will be explained in more detail below, the problem domain encompasses the region of the corrugated structure with isotropic properties. Shape functions for the nodes are then constructed in operation 404. Essentially, the displacement values or electric potential values are approximated using the shape functions. For example, in one exemplary embodiment, a Reproducing Kernel Particle Method (RKPM) with a Reproducing Kernel approximation with monomial basis functions may be used to construct the shape functions. In this exemplary embodiment, the discrete Reproducing Kernel approximation of a variable u, denoted by u^{h}, is

$${u}^{h} ( x ) = {\sum }_{I = 1}^{NP} {\overline{Φ}}_{a} ( x ; x - {x}_{I} ) {d}_{I} , \qquad ( 1.1 )$$

where NP is the number of discrete nodes, d_{I} are the coefficients of the approximation, and \overline{Φ}(x; x−x_{I}) is the Reproducing Kernel function that is constructed by a multiplication of two functions listed below in equation (1.2).
\overline{Φ}(x; x−x_{I})=C(x; x−x_{I})Φₐ(x−x_{I}) (1.2)
With reference to equation (1.2), the Φₐ(x−x_{I}) is a kernel function that defines the smoothness of the approximation with a compact support measured by “a,” and C(x;x−x_{I}) is an enrichment function (i.e., a correction function) that is used to satisfy the n-th order reproducing conditions:

$${\sum }_{I = 1}^{NP} \overline{Φ} ( x ; x - {x}_{I} ) {x}_{1 I}^{p} {x}_{2 I}^{q} {x}_{3 I}^{r} = {x}_{1}^{p} {x}_{2}^{q} {x}_{3}^{r} \qquad ( 1.3 )$$

for p+q+r=0, . . . , n (x_{I}≡x, x₂≡y, x₃≡z),
where x_{iI} is the nodal value of xᵢ at node I.

To meet the n-th order reproducing conditions of equation (1.3), the enrichment function C(x;x−x_{I}) is constructed by a linear combination of complete n-th order monomial functions as illustrated in equation (1.4).

$$\begin{matrix}C ( x ; x - {x}_{I} ) = {\sum }_{p + q + r = 0}^{n} {( {x}_{1} - {x}_{1 I} )}^{p} {( {x}_{2} - {x}_{2 I} )}^{q} {( {x}_{3} - {x}_{3 I} )}^{r} {b}_{pqr} ( x ) \\ ≡ {H}^{T} ( x - {x}_{I} ) b ( x )\end{matrix} \qquad ( 1.4 )$$

Here, b_{pqr}(x) are the coefficients of the monomial basis functions that are functions of x, b(x) is a vector of b_{pqr}(x), and H(x−x_{I}) is a vector containing the monomial basis functions which may be represented as:
H^{T}(x−x_{I})=[1, x₁−x_{1I}, x₂−x_{2I}, x₃−x_{3I},(x₁−x_{1I})², . . . , (x₃−x_{3I})ⁿ]. (1.5)
Equation (1.3) can be rewritten as:

$${\sum }_{I = 1}^{NP} H ( x - {x}_{I} ) \overline{Φ} ( x ; x - {x}_{I} ) = H ( 0 ) . \qquad ( 1.6 )$$

Substituting equation (1.4) into equation (1.6), the coefficients b(x) are solved by:
M(x)b(x)=H(0), (1.7)
where the moment matrix M(x) of (x−x_{I}) is constructed with the Reproducing Kernel function and the enrichment function:

$$M ( x ) = {\sum }_{I = 1}^{NP} H ( x - {x}_{I} ) {H}^{T} ( x - {x}_{I} ) {Φ}_{a} ( x - {x}_{I} ) . \qquad ( 1.8 )$$

For moment matrix M(x) in equation (1.8) to be invertible, the support of Φₐ(x−x_{I}) is greater than a minimum size that is related to the order of basis functions used in the enrichment function C(x; x−x_{I}) and the nodal spacing, and Φₐ(x−x_{I}) is a positive function within the support.

Using the solution of equations (1.2), (1.4), and (1.7), the Reproducing Kernel function is constructed by:

$${u}^{h} = {\sum }_{I = 1}^{NP} {Ψ}_{I} ( x ) {d}_{I} , \qquad ( 1.9 )$$

where Ψ_{I}(x) is the Reproducing Kernel shape functions of the approximation:
Ψ_{I}(x)=H^{T}(0)M⁻¹(x)H(x−x_{I})Φₐ(x−x_{I}). (1.10)
When monomial basis functions are used in the Reproducing Kernel function, the smoothness and compact support properties of the shape function Ψ_{I}(x) are identical to those of the kernel function Φₐ(x−x_{I}). The multi-dimensional kernel functions can be constructed by using the product of one-dimensional shape functions, or by considering the distance between nodes |x−x_{I}| as an independent variable in the evaluation of the kernel functions.

Still referring to FIG. 4, a set of equations is constructed in operation 406 by applying the shape functions to the governing equations. As discussed above, in one embodiment, if the modeled corrugated structure is that of a piezoelectric substrate, as shown in FIG. 2A, the meshfree method is applied using Newton's equation of motion as a governing equation. Newton's equation of motion for a linear elastic solid is given by:

$$\frac{\partial {σ}_{ij}}{\partial {x}_{j}} + {ω}^{2} ρ {u}_{i} = 0 , \qquad ( 2.1 )$$

where ω is the angular frequency, ρ is the mass density, σᵢⱼ is the stress tensor, and uᵢ is the displacements. The constitutive relations may be written as:
σᵢⱼ=Cᵢⱼₖₗεₖₗ, (2.2)
where εₖₗ is the strain and Cᵢⱼₖₗ is the elastic constant. The components of strain are obtained from displacement εᵢⱼ which may be represented as:

$${ɛ}_{ij} = \frac{1}{2} ( \frac{\partial {u}_{i}}{\partial {x}_{j}} + \frac{\partial {u}_{j}}{\partial {x}_{i}} ) . \qquad ( 2.3 )$$

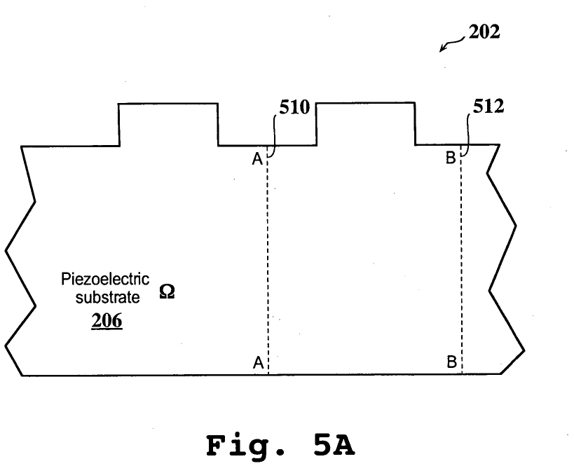

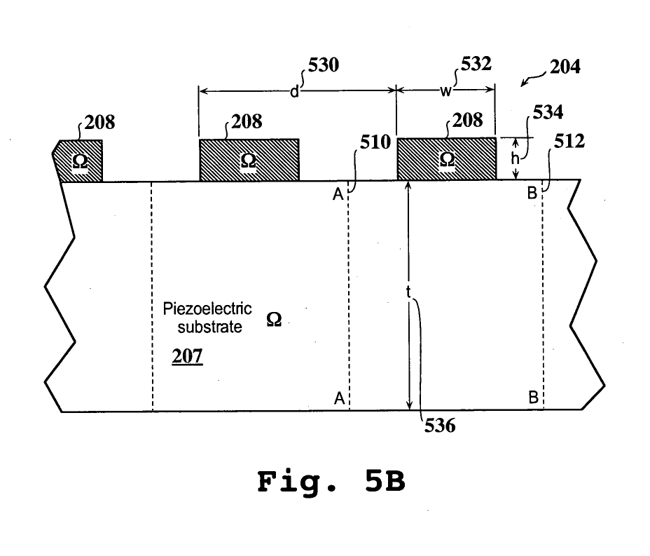

Denoting ν to be an arbitrary function, a weak form to the strong form given in equation (2.1) can be developed from the following equation:

$${\int }_{Ω} v ( \frac{\partial {σ}_{ij}}{\partial {x}_{j}} + {ω}^{2} ρ {u}_{i} ) ⅆ Ω = 0 , \qquad ( 2.4 )$$

where Ω represents the region of problem domain of a corrugated structure with isotropic properties. FIG. 5A is a more detailed view of the corrugated structure shown in FIG. 2A. As shown in FIG. 5A, the Ω represents the region of domain of corrugated structure 202 that includes piezoelectric substrate 206. Further, as will be explained in more detail below, interface boundary AA 510 and interface boundary BB 512 are used for applying boundary conditions.

Returning to equation (2.4), integrating equation (2.4) by parts gives the weak formulation:

$${\int }_{Ω} ( \frac{\partial v}{\partial {x}_{j}} ) {σ}_{ij} ⅆ Ω = {\int }_{Ω} v ( {ω}^{2} ρ {u}_{i} ) ⅆ Ω . \qquad ( 2.5 )$$

With regard to equation (2.5), the constraints on the stress on top and bottom are natural boundary conditions and will be automatically satisfied. Displacements and strains are approximated by:

$${u}^{h} = {\sum }_{I = 1}^{NP} {Ψ}_{I} {d}_{I} ≡ Ψ d and {ɛ}^{h} = {\sum }_{I = 1}^{NP} {B}_{I} {d}_{I} ≡ Bd , \qquad ( 2.6 )$$

where Ψ is the RKPM shape function developed in equation (1.9), B is the gradient matrix of Ψ, and d_{I} is a vector of approximation coefficients. Similarly, the arbitrary function ν is approximated by the RKPM shape functions listed below in equation (2.7).

$${v}^{h} = {\sum }_{I = 1}^{NP} {Ψ}_{I} {v}_{I} ⩵ Ψ v , \qquad ( 2.7 )$$

Here, d_{I} and ν_{I} are the unknowns associated with particle I. Substituting the RKPM approximations for u and v into weak formulation, the following matrix equation can be obtained:
Kd=ω²Md. (2.8)
Here,
K=∫_{Ω}B_{I}CB_{J}dΩ
M=∫_{Ω}ρΨ_{I}Ψ_{J}dΩ (2.9)
The K is the stiffness matrix, M is the mass matrix, d is a nodal displacement matrix, and C is the vector form of Cᵢⱼₖₗ.

On the other hand, in another embodiment, if the modeled corrugated structure is that of an electroded piezoelectric substrate, the meshfree method is applied using Newton's equation of motion and Gauss's equation of charge conservation as the governing equations. Newton's equation of motion and Gauss' equation of charge conservation are illustrated respectively in equation (3.1).

$$\begin{matrix}\frac{\partial {τ}_{ij}}{\partial {x}_{i}} + {ω}^{2} ρ {u}_{i} = 0 \\ \frac{\partial {D}_{i}}{\partial {x}_{i}} = 0\end{matrix} i , j = x , y , z \qquad ( 3.1 )$$

Here, τᵢⱼ is the stress tensor, ω is the angular frequency, ρ is the mass density, uᵢ is the particle displacement, and Dᵢ is the electrical displacement. The constitutive relations are:
τᵢⱼ=cᵢⱼₖₗSₖₗ−eₖᵢⱼEₖ
Dᵢ=eᵢⱼₖSⱼₖ+εᵢⱼEⱼ
i,j,k,l=x,y,z (3.2)
where cᵢⱼₖ, eᵢⱼₖ, and εᵢⱼ are the elastic constant, the piezoelectric constants, the dielectric permittivity at constant strain, respectively, and Sₖₗ and Eₖ are the strain tensor and the electric field, respectively. The strain tensor and electric field are related to the particle displacement, u, and the electric potential, φ, by

$$\begin{matrix}{S}_{ij} = \frac{1}{2} ( \frac{\partial {u}_{i}}{\partial {x}_{j}} + \frac{\partial {u}_{j}}{\partial {x}_{i}} ) \\ {E}_{i} = - \frac{\partial ϕ}{\partial {x}_{i}}\end{matrix} i , j = x , y , z \qquad ( 3.3 )$$

Denoting ν and μ to be an arbitrary function, a weak form to the strong form given in equation (3.1) can be developed from the following equation:

$${\int }_{Ω}^{} v ( \frac{\partial {τ}_{ij}}{\partial {x}_{i}} + {ω}^{2} ρ {u}_{i} ) ⅆ Ω + {\int }_{Ω}^{} μ ( \frac{\partial {D}_{i}}{\partial {x}_{i}} ) ⅆ Ω = 0 , \qquad ( 3.4 )$$

where Ω represents the region of problem domain of the corrugated structure, which includes piezoelectric substrate with a series of electrodes. FIG. 5B is a more detailed view of the corrugated structure shown in FIG. 2B. As shown in FIG. 5B, the Ω represents the region of problem domain of corrugated structure 204, which includes piezoelectric substrate 207 with a series of electrodes 208 disposed on top of the piezoelectric substrate. Additionally, as will be explained in more detail below, (d) 530 is the distance between electrodes 208, (w) 532 is the width of the electrode, (h) 534 is the height of the electrode, and (t) 536 is the thickness of piezoelectric substrate 207. Further, as will be explained in more detail below, interface boundary AA 510 and interface boundary BB 512 are used for applying boundary conditions.

Returning to equation (3.4), integrating equation (3.4) by parts gives the weak formulation listed below in equation (3.5).

$${\int }_{Ω}^{} ( \frac{\partial v}{\partial {x}_{j}} ) {σ}_{ij} ⅆ Ω + {\int }_{Ω}^{} v ( {ω}^{2} ρ {u}_{i} ) ⅆ Ω + {\int }_{Ω}^{} ( \frac{\partial μ}{\partial {x}_{i}} ) {D}_{i} ⅆ Ω = 0. \qquad ( 3.5 )$$

Again, constraints on the stress on top and bottom are natural boundary conditions and will be automatically satisfied. Displacements and strains are approximated by:

$${u}^{h} = {\sum }_{I = 1}^{NP} {Ψ}_{I}^{d} {d}_{I} and {ɛ}^{h} = {\sum }_{I = 1}^{NP} {B}_{I}^{d} {d}_{I} . \qquad ( 3.6 )$$

Electric potential and electric field are approximated by:

$${ϕ}^{h} = {\sum }_{I = 1}^{NP} {Ψ}_{I}^{ϕ} {φ}_{I} and {E}^{h} = - {\sum }_{I = 1}^{NP} {B}_{I}^{ϕ} {φ}_{I} , \qquad ( 3.7 )$$

where Ψ is the RKPM shape function developed in equation (1.9), B is the gradient matrix of Ψ and d_{I}, and φ_{I} is a vector of approximation coefficients. Similarly, the arbitrary function ν is approximated by the RKPM shape functions listed below in equation (3.8).

$${v}^{h} = {\sum }_{I = 1}^{NP} {Ψ}_{I} {v}_{I} , {μ}^{h} = {\sum }_{I = 1}^{NP} {Ψ}_{I} {μ}_{I} \qquad ( 3.8 )$$

Here, d_{I}, φ_{I}, ν_{I} and μ_{I} are the unknowns associated with particle I. Substituting the RKPM approximations for u, φ, ν and μ into weak formulation, the RKPM matrix form of a piezoelectric problem is listed below in equation (3.9).

$$Kd = {w}^{2} Md \\ where \\ K = [ \begin{matrix}{K}_{uu} & {K}_{u ϕ} \\ {K}_{ϕ u} & {K}_{ϕ ϕ}\end{matrix} ] , M = [ \begin{matrix}{M}_{uu} & 0 \\ 0 & 0\end{matrix} ] , d = \{ \begin{matrix}d \\ φ\end{matrix} \} \qquad ( 3.9 )$$

With reference to equation (3.9),

$${K}_{uu} = {\int }_{Ω}^{} {B}_{I}^{u} {CB}_{I}^{u} ⅆ Ω {K}_{u ϕ} = {\int }_{Ω}^{} {B}_{I}^{u} {CB}_{I}^{ϕ} ⅆ Ω \\ {K}_{ϕ u} = {\int }_{Ω}^{} {B}_{I}^{ϕ} {CB}_{I}^{u} ⅆ Ω {K}_{ϕ ϕ} = {\int }_{Ω}^{} {B}_{I}^{ϕ} {CB}_{I}^{ϕ} ⅆ Ω \\ and {M}_{uu} = {\int }_{Ω}^{} ρ {ψ}_{l}^{u} {ψ}_{J}^{u} ⅆ Ω \qquad ( 3.10 )$$

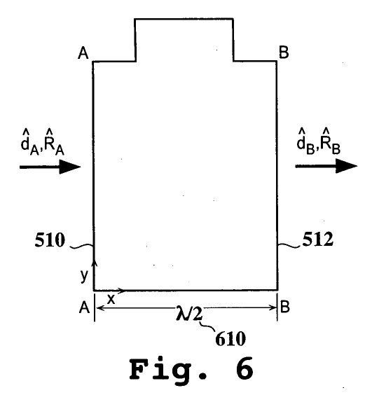

Returning to FIG. 4, in operation 408, boundary conditions, initial conditions, and loads are then applied. In particular, by noting the periodic nature of the corrugated structure, the analysis problem domain can be simplified to a portion of the corrugated structure. FIG. 6 is a side view of the simplified problem domain, in accordance with one embodiment of the present invention. Specifically, for both embodiments of the modeled corrugated structures with the piezoelectric substrate and with the electrode disposed on top of the piezoelectric substrate, the analysis problem domain may be limited to a portion of the corrugated structure between interface boundary AA 510 and interface boundary BB 512, as shown in FIGS. 5A and 5B. As shown in FIG. 6, d is a nodal displacement and \hat{R} is the nodal reaction force from the removed corrugated structure. Width 610 of the portion of the corrugated structure is λ/2, where λ is the wavelength of the SAW.

In one embodiment, in order for the simplified problem domain to represent a periodic, corrugated structure that includes a piezoelectric substrate, the following constraints are imposed:
\hat{d}_{A}=−\hat{d}_{B}
\hat{R}_{A}=\hat{R}_{B} (4.1)
In general, the shape functions do not have Kronecker delta properties, which means that the displacement d in equation (1.9) is not a nodal value. Therefore, a generalized form of matrix equation (2.8) is transformed into a nodal form. A transformation method can be introduced for this purpose. From equation (1.9), denoting \hat{d}ᵢⱼ=uᵢ(X_{J}),

$$\begin{matrix}{\hat{d}}_{iJ} = {\sum }_{I = 1}^{NP} {Ψ}_{I} ( {X}_{J} ) {d}_{iI} = {\sum }_{I = 1}^{NP} {A}_{IJ} {d}_{il} & ( 4.2 ) \\ {d}_{iI} = {\sum }_{K = 1}^{NP} {A}_{KI}^{- 1} {\hat{d}}_{iK} , \\ where & ( 4.3 ) \\ {A}_{IJ} = {Ψ}_{I} ( {X}_{J} ) . & ( 4.4 )\end{matrix}$$

Substituting equation (4.3) to equation (1.9) leads to

$$\begin{matrix}{u}_{i}^{h} ( X ) = {\sum }_{I = 1}^{NP} {Ψ}_{I} ( X ) {d}_{iI} = {\sum }_{I = 1}^{NP} {\sum }_{K = 1}^{NP} {Ψ}_{I} ( X ) {A}_{KI}^{- 1} {\hat{d}}_{iK} = {\sum }_{K = 1}^{NP} {\hat{Ψ}}_{K} ( X ) {\hat{d}}_{iK} , \\ where & ( 4.5 ) \\ {\hat{Ψ}}_{K} ( X ) = {\sum }_{K = 1}^{NP} {A}_{KI}^{- 1} {Ψ}_{I} ( X ) . & ( 4.6 )\end{matrix}$$

Here,

$${\hat{Ψ}}_{I} ( {X}_{J} ) = {\sum }_{K = 1}^{NP} {A}_{IK}^{- 1} {Ψ}_{K} ( {X}_{J} ) = {\sum }_{K = 1}^{NP} {A}_{IK}^{- 1} {A}_{KJ} = {δ}_{IJ} , and {\hat{d}}_{iI} = {u}_{i} ( {X}_{I} )$$

is the nodal value of uᵢ. Therefore, equation (2.8) can be transformed into the following matrix in nodal form
\hat{Kd}=ω²\hat{Md}, (4.7)
where
\hat{K}=λ⁻¹Kλ^{-T}
and
\hat{M}=λ⁻¹Mλ^{-T}
λᵢⱼ=AᵢⱼI (4.8)

An equivalent matrix form of equation (4.7) that includes the periodic condition of equation (4.1) may be then written as:

$$[ \begin{matrix}{\hat{K}}_{II} & {\hat{K}}_{IA} & {\hat{K}}_{IB} \\ {\hat{K}}_{AI} & {\hat{K}}_{AA} & {\hat{K}}_{AB} \\ {\hat{K}}_{BI} & {\hat{K}}_{BA} & {\hat{K}}_{BB}\end{matrix} ] [ \begin{matrix}{\hat{d}}_{I} \\ {\hat{d}}_{A} \\ {\hat{d}}_{B}\end{matrix} ] = {ω}^{2} [ \begin{matrix}{\hat{M}}_{II} & {\hat{M}}_{IA} & {\hat{M}}_{IB} \\ {\hat{M}}_{AI} & {\hat{M}}_{AA} & {\hat{M}}_{AB} \\ {\hat{M}}_{BI} & {\hat{M}}_{BA} & {\hat{M}}_{BB}\end{matrix} ] [ \begin{matrix}{\hat{d}}_{I} \\ {\hat{d}}_{A} \\ {\hat{d}}_{B}\end{matrix} ] + [ \begin{matrix} \\ {\hat{R}}_{A} \\ {\hat{R}}_{B}\end{matrix} ] , \qquad ( 4.9 )$$

where the subscripts A and B denote nodal degree of freedom on interface boundary AA 510 and interface boundary BB 512, respectively, and the subscript I denotes all remaining degree of freedom. The matrix equation may be further simplified by eliminating the third row by imposing the periodic constraint of equation (4.1). As such,

$$[ \begin{matrix}{\hat{K}}_{II} & {\hat{K}}_{IA} + {\hat{K}}_{IB} \\ SYM & {\hat{K}}_{AA} + {\hat{K}}_{BB}\end{matrix} ] [ \begin{matrix}{\hat{d}}_{I} \\ {\hat{d}}_{A}\end{matrix} ] = {ω}^{2} [ \begin{matrix}{\hat{M}}_{II} & {\hat{M}}_{IA} - {\hat{M}}_{IB} \\ SYM & {\hat{M}}_{AA} - {\hat{M}}_{BB}\end{matrix} ] [ \begin{matrix}{\hat{d}}_{I} \\ {\hat{d}}_{A}\end{matrix} ] , \qquad ( 4.10 )$$

and equation (4.10) is a general form of an eigenvalue problem.

In another embodiment, for a modeled corrugated structure that includes electrodes disposed on top of a piezoelectric substrate, the boundary conditions are imposed using a general form of Floquet's theorem:
\hat{d}_{B}(x=d)=ζ\hat{d}_{A}(x=0)
\hat{R}_{B}(x=d)=−ζ\hat{R}_{A}(x=0)
where
ζ=exp(−jβd) (5.1)
on the planes x=0, d, where β is the wave number in the x direction.

In general, the RKPM shape functions do not have Kronecker delta properties, which means that the displacement d in equation (1.9) is not a nodal value. Therefore, a generalized form of matrix equation (3.9) is transformed into a nodal form. A transformation method is introduced for the purpose. From equation (1.9), denoting \hat{d}ᵢⱼ=uᵢ(X_{J}),

$$\begin{matrix}{\hat{d}}_{iJ} = {\sum }_{I = 1}^{NP} {Ψ}_{I} ( {X}_{J} ) {d}_{iI} = {\sum }_{I = 1}^{NP} {A}_{IJ} {d}_{iI} \\ or & ( 5.2 ) \\ {d}_{iI} = {\sum }_{K = 1}^{NP} {A}_{KI}^{- 1} {\hat{d}}_{iK} , \\ where & ( 5.3 ) \\ {A}_{IJ} = {Ψ}_{I} ( {X}_{J} ) . & ( 5.4 )\end{matrix}$$

Substituting equation (5.3) to equation (1.9) leads to

$$\begin{matrix}{u}_{i}^{h} ( X ) = {\sum }_{I = 1}^{NP} {Ψ}_{I} ( X ) {d}_{iI} = {\sum }_{I = 1}^{NP} {\sum }_{K = 1}^{NP} {Ψ}_{I} ( X ) {A}_{KI}^{- 1} {\hat{d}}_{iK} = {\sum }_{K = 1}^{NP} {\hat{Ψ}}_{K} ( X ) {\hat{d}}_{iK} , \\ where & ( 5.5 ) \\ {\hat{Ψ}}_{K} ( X ) = {\sum }_{K = 1}^{NP} {A}_{KI}^{- 1} {Ψ}_{I} ( X ) . & ( 5.6 )\end{matrix}$$

Here,

$${\hat{Ψ}}_{I} ( {X}_{J} ) = {\sum }_{K = 1}^{NP} {A}_{Ik}^{- 1} {Ψ}_{K} ( {X}_{J} ) = {\sum }_{K = 1}^{NP} {A}_{IK}^{- 1} {A}_{KJ} = {δ}_{IJ} , and {\hat{d}}_{iI} = {u}_{i} ( {X}_{I} )$$

is the nodal value of uᵢ. Therefore, equation (3.9) can be transformed to the following matrix in nodal form:
\hat{K}\hat{d}=ω²\hat{M}\hat{d}, (5.7)
where
\hat{K}=λ⁻¹Kλ^{-T}
and
\hat{M}=λ⁻¹Mλ^{-T}
\hat{d}=λ^{-T}d
λᵢⱼ=AᵢⱼI (5.8)
An equivalent matrix form of equation (5.7) that includes the periodic condition of equation (5.1) may then be written as:

$$[ \begin{matrix}{\hat{K}}_{II} & {\hat{K}}_{IA} & {\hat{K}}_{IB} \\ {\hat{K}}_{AI} & {\hat{K}}_{AA} & {\hat{K}}_{AB} \\ {\hat{K}}_{BI} & {\hat{K}}_{BA} & {\hat{K}}_{BB}\end{matrix} ] [ \begin{matrix}{\hat{d}}_{I} \\ {\hat{d}}_{A} \\ {\hat{d}}_{B}\end{matrix} ] = {ω}^{2} [ \begin{matrix}{\hat{M}}_{II} & {\hat{M}}_{IA} & {\hat{M}}_{IB} \\ {\hat{M}}_{AI} & {\hat{M}}_{AA} & {\hat{M}}_{AB} \\ {\hat{M}}_{BI} & {\hat{M}}_{BA} & {\hat{M}}_{BB}\end{matrix} ] [ \begin{matrix}{\hat{d}}_{I} \\ {\hat{d}}_{A} \\ {\hat{d}}_{B}\end{matrix} ] + [ \begin{matrix} \\ {\hat{R}}_{A} \\ {\hat{R}}_{B}\end{matrix} ] , \qquad ( 5.9 )$$

where the subscripts A and B denote nodal degree of freedom on interface boundary AA 510 and interface boundary BB 512, respectively, and the subscript I denotes all remaining degree of freedom. The matrix equation may be further simplified by eliminating the third row by imposing the periodic constraint of equations (5.1):

$$[ \begin{matrix}{\hat{K}}_{II} & {\hat{K}}_{IA} + ζ {\hat{K}}_{IB} \\ {\hat{K}}_{AI} + {ζ}^{*} {\hat{M}}_{BI} & {\hat{K}}_{AA} + {\hat{K}}_{BB}\end{matrix} ] [ \begin{matrix}{\hat{d}}_{I} \\ {\hat{d}}_{A}\end{matrix} ] = {w}^{2} [ \begin{matrix}{\hat{M}}_{II} & {\hat{M}}_{IA} + ζ {\hat{M}}_{IB} \\ {\hat{M}}_{AI} + {ζ}^{*} {\hat{M}}_{BI} & {\hat{M}}_{AA} + {\hat{M}}_{BB}\end{matrix} ] [ \begin{matrix}{\hat{d}}_{I} \\ {\hat{d}}_{A}\end{matrix} ] . \qquad ( 5.10 )$$

By definition, \hat{K}_{AB} is a zero matrix and * denotes a complex conjugate.

Equation (5.7) is a generalized eigenvalue problem with Hermitian coefficient matrices. One skilled in the art will appreciate that there are various computer programs available that may be utilized to solve the eigenvalue problem. For example, ARPACK (Arnoldi Package), a publicly available computer program designed to solve large-scale eigenvalue programs, may be used to solve the eigenvalue problem referred to in equation (5.10). ARPACK is based on the Arnorldi method and is effective on handling large-scale eigenvalue problems with real or complex coefficient matrices. A shift and an invert spectral transformation may be used to accelerate the solution procedure. Equation (5.7) can be rewritten as:
Kx=w²Mx=λMx. (5.11)
If (λ, x) is an eigenpair for (K, M) and σ≢λ, then

$${( K - σ M )}^{- 1} M x = vx , where v = \frac{1}{λ - σ} \qquad ( 5.12 )$$

With equation (5.12), the original eigenvalue problem of equation (5.7) is hence shifted and inverted to effectively find eigenvalues near σ.

It should be appreciated that the RKPM meshfree method discussed above illustrates just one exemplary embodiment of the application of a meshfree method to a corrugated structure. Many other types of meshfree methods may be applied to the corrugated structure, such as, for example, Smooth Particle Hydrodynamics (SPH), Element-Free Galerkin (EFG), Diffuse Element Method, h-p Cloud Method, Meshfree Local Petrov-Galerkin Method (MLPG), etc. SPH is believed to be one of the earliest meshfree methods developed and it is mainly applied to problems that do not have finite boundaries. EFG shares the derivation of shape function with SPH, but differs in its numerical implementation using Galerkin weak form while SPH adopts collocation of the strong form at the nodes. RKPM introduces a correction function applied to the shape function to improve the accuracy of SPH. It should be further appreciated that MLPG uses a local weak form over a local sub-domain Ωs, which is located entirely inside the global domain Ω. Using a local weak form is the most distinguishing feature of the MLPG from other Galerkin meshfree methods (e.g., EFG, MLPG, etc.), which generally deal with the global domain.

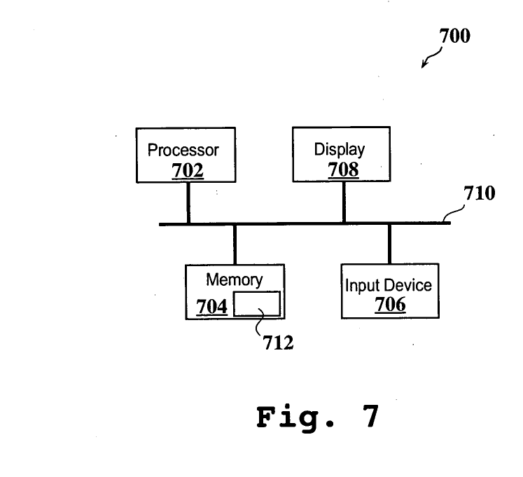

The modeling of a corrugated structure and the application of the mathematical principles described above for simulating a SAW on the modeled corrugated structure may be incorporated into a computer readable medium for use in a computer system. FIG. 7 is a simplified block diagram of a high level overview of a computer system for simulating a SAW on a structure, in accordance with one embodiment of the present invention. As shown in FIG. 7, computer system 700 includes processor 702, display 708 (e.g., liquid crystal (LCD) displays, thin-film transistor (TFT) displays, cathode ray tube (CRT) monitors, etc.), memory 704 (e.g., static access memory (SRAM), dynamic random access memory (DRAM), hard disk drives, optical disc drives, etc.), and input device 706 (e.g., mouse, keyboard, etc.). Each of these components may be in communication through common bus 710. In one exemplary embodiment, meshfree analysis program 712 stored in memory 704 and executed by processor 702 includes program instructions for applying the meshfree method to a modeled corrugated structure and program instructions for solving a set of equations simultaneously to obtain numerical results.

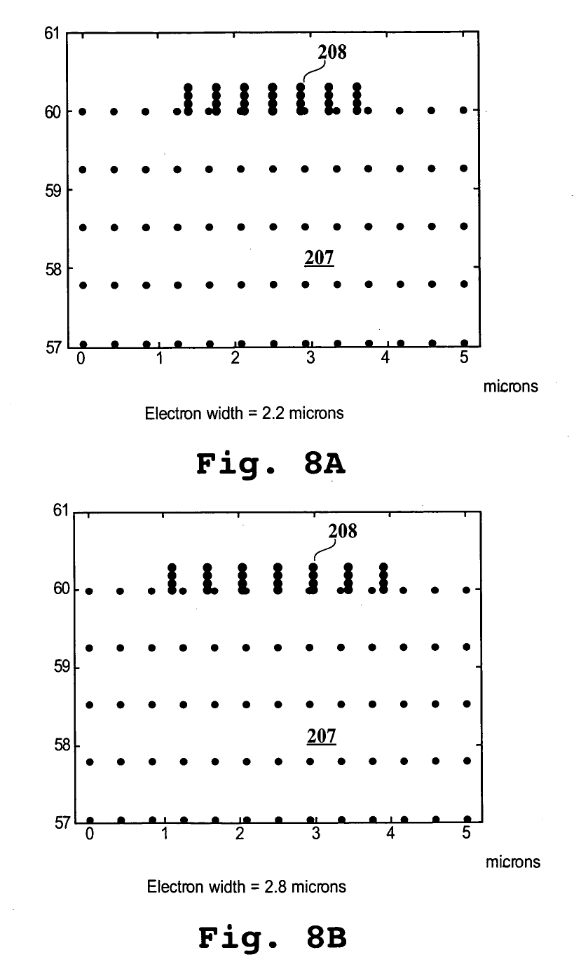

In summary, the above-described invention provides a method and a system of simulating a SAW on a modeled structure. In one embodiment, a meshfree method is applied to a modeled corrugated structure using a Newton's equation of motion as the governing equation. In another embodiment, the meshfree method is applied to a modeled corrugated structure using Newton's equation of motion and Gauss's equation of charge conservation as governing equations. The application of the meshfree method to a modeled corrugated structure to simulate a SAW results in less computational cost and higher degree of accuracy as compared to the traditional FE method. For example, FIGS. 8A and 8B show two discretizations with different electron widths, in accordance with embodiments of the present invention. The corrugated structures shown in FIGS. 8A and 8B are SAW filters typically used in cellular phones for signal processing. In these examples, with reference to FIG. 5B, thickness (t) 536 of piezoelectric substrate 207 is taken as 60 microns, height (h) 534 of electrode 208 is 0.3 microns, and distance (d) 530 between the neighboring electrodes is 5 microns. The width (w) 532 of electrode 208 is varied from 2.2 microns, as shown in FIG. 8A, to 2.8 microns, as shown in FIG. 8B, to see the effect of width change on frequency. As shown in FIGS. 8A and 8B, since the meshfree method is free from element compatibility, only the discretization of electrode 208 changes while the discretization of piezoelectric substrate 207 stays unchanged during the entire analyses. If an FE method is used, piezoelectric substrate 207 must be repeatedly re-meshed for each analysis, which results in high computation cost. As a result, the application of the meshfree method expedites the design of SAW devices, such as the SAW filters illustrated in FIGS. 8A and 8B, when compared to the conventional application of the FE method.

With the above embodiments in mind, it should be understood that the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

The invention can also be embodied as computer readable code on a computer readable medium. The computer readable medium is any data storage device that can store data, which can be thereafter read by a computer system. The computer readable medium also includes an electromagnetic carrier wave in which the computer code is embodied. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer system so that the computer readable code is stored and executed in a distributed fashion.

Any of the operations described herein that form part of the invention are useful machine operations. The invention also relates to a device or an apparatus for performing these operations. The apparatus may be specially constructed for the required purposes, or it may be a general-purpose computer selectively activated or configured by a computer program stored in the computer. In particular, various general-purpose machines may be used with computer programs written in accordance with the teachings herein, or it may be more convenient to construct a more specialized apparatus to perform the required operations.

The above-described invention may be practiced with other computer system configurations including hand-held devices, microprocessor systems, microprocessor-based or programmable consumer electronics, minicomputers, mainframe computers and the like. Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims. In the claims, elements and/or steps do not imply any particular order of operation, unless explicitly stated in the claims.

What is claimed is:

1. A method of simulating a surface acoustic wave on a modeled structure, comprising method operations of:
modeling a structure that is capable of generating a surface acoustic wave;
applying a meshfree method to the modeled structure using an equation of motion and an equation of charge conservation as governing equations; and
solving a set of equations simultaneously to obtain numerical results.

2. The method of claim 1, wherein the method operation of applying the meshfree method includes,
generating nodes within a problem domain;
constructing shape functions for the nodes;
constructing the set of equations by applying the shape functions to the governing equations; and
applying boundary conditions, initial conditions, and loads.

3. The method of claim 2, wherein the method operation of constructing the shape functions for the nodes includes,
constructing a Reproducing Kernel function;
constructing an enrichment function by a linear combination of complete n-th order monomial functions;
constructing a moment matrix with the Reproducing Kernel function and the enrichment function; and
constructing the shape functions from the Reproducing Kernel function, the enrichment function, and the moment matrix,
wherein the meshfree method is a Reproducing Kernel Particle Method.

4. The method of claim 1, wherein the set of equations is a matrix in the form of
Kd=ω²Md,
wherein K is a stiffness matrix, M is a mass matrix, the ω is an angular velocity, and d is a nodal displacement matrix.

5. The method of claim 1, wherein the numerical results includes one of displacement values or electric potential values.

6. The method of claim 5, wherein the displacement values or the electric potential values are approximated using shape functions.

7. The method of claim 1, wherein the meshfree method is selected from the group consisting of a Reproducing Kernel Particle Method, Smooth Particle Hydrodynamics, Element-Free Galerkin, Diffuse Element Method, h-p Cloud Method, and Meshfree Local Petrov-Galerkin Method.

8. The method of claim 1, wherein the modeled structure includes properties and dimensions of a material selected from the group consisting of a quartz, a barium titanate, a lithium tantalate, a lithium niobate, a gallium arsenide, a silicon carbide, a langasite, a zinc oxide, an aluminum nitride, a lead zirconium titanate, and a polyvinylidene fluoride.

9. The method of claim 1, wherein the equation of motion is defined by
$$\frac{\partial {τ}_{ij}}{\partial {x}_{i}} + {ω}^{2} ρ {u}_{i} = 0 ,$$
wherein the τᵢⱼ is a stress tensor, the ω is an angular frequency, the ρ is a mass density, and the uᵢ is a displacement.

10. The method of claim 1, wherein the equation of charge conservation is defined by
$$\frac{\partial {D}_{i}}{\partial {x}_{i}} = 0 ,$$
wherein the Dᵢ is an electrical displacement.

11. A computer readable medium having program instructions for simulating a surface acoustic wave on a modeled structure, comprising:
program instructions for modeling a structure that is capable of generating a surface acoustic wave;
program instructions for applying a meshfree method to the corrugated structure using an equation of motion and an equation of charge conservation as governing equations; and
program instructions for solving a set of equations simultaneously to obtain numerical results.

12. The computer readable medium of claim 11, wherein the program instructions for applying the meshfree method include,
program instructions for generating nodes within a problem domain;
program instructions for constructing shape functions for the nodes;
program instructions for constructing the set of equations by applying the shape functions to the governing equation; and
program instructions for applying boundary conditions, initial conditions, and loads.

13. The computer readable medium of claim 12, wherein the program instructions for constructing the shape functions for the nodes include,
program instructions for constructing a Reproducing Kernel function;
program instructions for constructing an enrichment function by a linear combination of complete n-th order monomial functions;
program instructions for constructing a moment matrix with the Reproducing Kernel function and the enrichment function; and
program instructions for constructing the shape functions from the Reproducing Kernel function, the enrichment function, and the moment matrix,
wherein the meshfree method is a Reproducing Kernel Particle Method.

14. The computer readable medium of claim 11, wherein the set of equations is a matrix in the form of
Kd=ω²Md,
wherein the K is a stiffness matrix, the M is a mass matrix, the ω is an angular velocity, and the d is a nodal displacement matrix.

15. The computer readable medium of claim 11, wherein the numerical results are displacement values.

16. The computer readable medium of claim 15, wherein the displacement values are approximated using shape functions.

17. The computer readable medium of claim 11, wherein the equation of motion is defined by
$$\frac{\partial {σ}_{ij}}{\partial {x}_{i}} + {ω}^{2} ρ {u}_{i} = 0 ,$$
wherein the σᵢⱼ is a stress tensor, the ω is an angular frequency, the ρ is a mass density, and the uᵢ is a displacement.

18. A computer system for simulating a surface acoustic wave on a modeled structure, comprising:
a memory configured to store or receive a meshfree analysis program; and
a processor configured to execute the meshfree analysis program residing in the memory,
the meshfree analysis program including,
program instructions for applying a meshfree method to a model of structure that is capable of generating a surface acoustic wave using an equation of motion as a governing equation, and
program instructions for solving a set of equations simultaneously to obtain numerical results.

19. The computer system of claim 18, wherein the modeled structure is of a piezoelectric substrate having an electrode disposed thereon.

20. The computer system of claim 18, wherein the governing equation further includes an equation of charge conservation.
